(19) United States
(12) Patent Application Publication
(10) Pub. No.: US 2024/0393760 A1
(43) Pub. Date: Nov. 28, 2024

(54) MACHINING SHAPE MODEL COMPARISON DEVICE AND NUMERICAL CONTROL MACHINE SYSTEM

(71) Applicant: FANUC CORPORATION, Yamanashi (JP)

(72) Inventor: Hiroaki HADA, Yamanashi (JP)

(73) Assignee: FANUC CORPORATION, Yamanashi (JP)

(21) Appl. No.: 18/696,870

(22) PCT Filed: Oct. 19, 2021
(86) PCT No.: PCT/JP2021/038648

§ 371 Date: Mar. 28, 2024

(51) Int. Cl. G05B 19/18

(52) U.S. Cl. CPC G05B 19/182; G05B 2219/35519

(57) ABSTRACT

The present invention enables the simple determination of the cause of an abnormality of a machined surface of a machined workpiece regardless of the proficiency of a user.

The present invention comprises: a machining shape model storage unit that stores at least a first, second, and third machining shape model which are generated on the basis of three machining position data items of at least three steps in series of machining an object with a machine tool; a machining shape model selection unit that selects the first and second machining shape models, and the second and third machining shape models; a machining shape model acquisition unit that acquires the first and second machining shape models and also acquires the second and third machining shape models; and a difference calculation unit that finds a set of the distances between the machined surface of the first machining shape model and the machined surface of the second machining shape model as a first difference set, and finds a set of the distances between the machined surface of the second machining shape model and the machining surface of the third machining shape model as a second difference set.

### TECHNICAL FIELD

The present invention relates to a machining-shape-model comparison device and a numerical control machine system, and, in particular, pertains to a machining-shape-model comparison device for comparing machining shape models of an object machined with a machine tool, and a numerical control machine system including the machining-shape-model comparison device.

### BACKGROUND ART

Patent Document 1 describes a simulation device that allows for easy identification of causative factors of a machining problem with an object or easy checking of the effectiveness of an adjustment of, for example, machining programs, control commands such as position commands, servo control, or machine operations. This simulation device includes: a plurality of storage units for storing a plurality of pieces of machining position data obtained from at least two from among a machining program, a control command for performing servo control for a servo motor for driving a machine tool, and feedback information from the servo motor and the machine tool, the machining program, the control command, and the feedback information being provided when an object is machined with the machine tool; a machined-surface simulation unit that simulates a plurality of machined surfaces by using the plurality of stored machining position data; and a display unit that displays, next to each other, images of the plurality of machined surfaces that have been obtained through the simulation of the plurality of machined surfaces.

Patent Document 2 describes a numerical control simulation device capable of estimating, from a numerical control program and drive system characteristics, a machining shape of an object (workpiece) that would be achieved if machining is performed. This numerical control simulation device includes: a program reading unit that reads a numerical control program specifying a workpiece machining route; a preprocessing unit that compensates the read specified route by using a compensation parameter so as to determine a compensated route; an interpolation and acceleration/deceleration unit that performs interpolation and/or acceleration/deceleration on the basis of the compensated route and an acceleration/deceleration parameter; a drive system model that estimates a tool leading-end position by using a servo parameter for the result of interpolation and/or acceleration/deceleration; a 3D solid simulation unit that performs a 3D solid simulation by using the tool leading-end position so as to calculate an estimated machining shape; a shape display unit that displays the estimated machining shape that has been calculated; and a shape-error calculation unit that calculates a shape error by comparing a target machining shape with the estimated machining shape.

### CITATION LIST

### Patent Document

Patent Document 1: Japanese Unexamined Patent Application, Publication No. 2021-071951
Patent Document 2: Japanese Patent No. 3399419

### DISCLOSURE OF THE INVENTION

### Problems to be Solved by the Invention

Patent Document 1 indicates that, by using a simulation of machined surfaces, it can be easily identified which factor from among a machining program, a control command for performing servo control for a servo motor for driving a machine tool, servo control, and an element (process) of a machine operation has caused an abnormality of the machined surface of a machined object (workpiece). Patent Document 2 indicates that operators (users) can make use of the invention therein in estimating what factor has provided a site with a large shape error.

However, the technique described in Patent Document 1 does not necessarily allow the user to easily assess an abnormality of the machined surface of a machined object by viewing the display unit, which displays an image of a plurality of machined surfaces obtained by simulating a plurality of machined surfaces. Unlike Patent Document 1, Patent Document 2 does not describe a situation in which a plurality of factors have caused an abnormality of the machined surface of a machined object.

Accordingly, if there are a plurality of factors (processes) that could cause an abnormality of the machined surface of a machined object, it is desirable to allow the user to easily identify which factor has caused the abnormality of the machined surface of the machined object. It is also desirable to allow a quantitative assessment to be made as to which factor has caused an abnormality of the machined surface of a machined object.

### Means for Solving the Problems

(1) A first aspect of the present disclosure is a machining-shape-model comparison device including: a machining-shape-model storage unit that stores at least a first machining shape model, a second machining shape model, and a third machining shape model that are generated on the basis of three pieces of machining position data pertaining to at least three serial processes when an object is machined with a machine tool; a machining-shape-model selection unit that selects the first and second machining shape models and the second and third machining shape models that are stored by the machining-shape-model storage unit; a machining-shape-model acquisition unit that acquires the first and second machining shape models and the second and third machining shape models that have been selected by the machining-shape-model selection unit; and a difference calculation unit that determines, as a first set of difference values, a set of distances between machined surfaces of the first machining shape model and the second machining shape model acquired by the machining-shape-model acquisition unit, and determines, as a second set of difference values, a set of distances between machined surfaces of the second machining shape model and the third machining shape model acquired by the machining-shape-model acquisition unit.

(2) A second aspect of the present disclosure is a machining-shape-model comparison device including: a machining-shape-model storage unit that stores at least a first machining shape model and a second machining shape model that are generated on the basis of two pieces of machining position data pertaining to at least two serial processes when an object is machined with a machine tool; a machining-shape-model selection unit that selects the first and second machining shape models stored by the machining-shape-model storage unit; a machining-shape-model acquisition unit that acquires the first and second machining shape models selected by the machining-shape-model selection unit; and a difference calculation unit that determines, as a set of difference values, a set of distances between machined surfaces of the first machining shape model and the second machining shape model acquired by the machining-shape-model acquisition unit; and a difference-evaluation-value calculation unit that determines a statistic pertaining to the set of difference values as an evaluation value.

(3) A third aspect of the present disclosure is a numerical control machine system including: the machining-shape-model comparison device described in (1) above; and a numerical control device that includes a simulation unit for generating at least first, second, and third machining shape models on the basis of three pieces of machining position data pertaining to at least three serial processes when an object is machined with a machine tool.

(4) A fourth aspect of the present disclosure is a computer-readable information storage medium having stored therein a program for causing a computer to store at least a first machining shape model, a second machining shape model, and a third machining shape model that are generated on the basis of three pieces of machining position data pertaining to at least three serial processes when an object is machined with a machine tool, select the first and second machining shape models and the second and third machining shape models that have been stored, acquire the first and second machining shape models and the second and third machining shape models that have been selected; and determine, as a first set of difference values, a set of distances between machined surfaces of the first machining shape model and the second machining shape model that have been acquired, and determine, as a second set of difference values, a set of distances between machined surfaces of the second machining shape model and the third machining shape model that have been acquired.

### Effects of the Invention

According to aspects of the present disclosure, when there are at least three serial processes in machining an object with a machine tool, the user can easily identify which process has caused an abnormality of the machined surface of the machined object. Moreover, aspects of the present disclosure allow a quantitative assessment to be made as to which process has caused an abnormality of the machined surface of an object that has been machined.

### BRIEF DESCRIPTION OF THE DRAWINGS

FIG. 1 is a block diagram illustrating one configuration example of a numerical control machine system including a machining-shape-model comparison device according to a first embodiment of the present invention;

FIG. 2 is a perspective view illustrating a machining shape model of an object;

FIG. 3 is a block diagram illustrating one configuration example of the machining-shape-model comparison device according to the first embodiment of the present invention;

FIG. 4 is a schematic explanatory view illustrating a method for determining the distance between the machined surfaces of two machining shape models as a difference value;

FIG. 5 is a flowchart illustrating operations of a machining-shape-model comparison device;

FIG. 6 is a block diagram illustrating one configuration example of a machining-shape-model comparison device according to a second embodiment of the present invention;

FIG. 7 illustrates a display screen of a difference display unit; and

FIG. 8 is a block diagram illustrating one configuration example of a machining-shape-model comparison device according to a third embodiment of the present invention.

### PREFERRED MODE FOR CARRYING OUT THE INVENTION

The following describes embodiments of the present invention in detail by using the drawings.

### First Embodiment

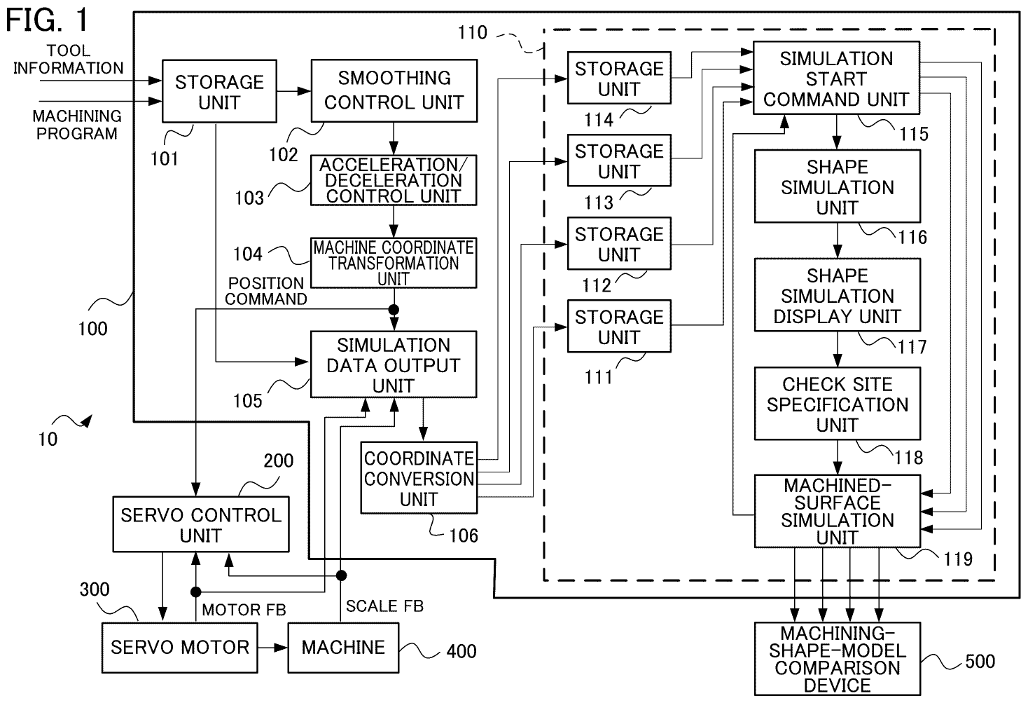

FIG. 1 is a block diagram illustrating one configuration example of a numerical control machine system including a machining-shape-model comparison device according to the first embodiment of the present invention. A numerical control machine system (hereinafter referred to as NC machine system) 10 depicted in FIG. 1 includes a numerical control device (hereinafter referred to as NC device) 100, a servo control unit 200, a servo motor 300, a machine 400, and a machining-shape-model comparison device 500. The machine 400 is a machine tool that performs, for example, cutting machining. The NC device 100 may be included in the machine 400. The servo motor 300 may be included in the machine 400. The machining-shape-model comparison device 500 may be included in the NC device 100. When the machine 400 includes a plurality of axes, e.g., three axes, namely, an X axis, a Y axis, and a Z axis, the servo control unit 200 and the servo motor 300 are provided for each axis.

The NC device 100 includes a storage unit 101, a smoothing control unit 102, an acceleration/deceleration control unit 103, a machine coordinate transformation unit 104, a simulation data output unit 105, a coordinate conversion unit 106, and a simulation unit 110. Details of the configurations and operations of the NC machine system 10 other than those of the machining-shape-model comparison device 500 are described in Patent Document 1, so the following simply describes these configurations and operations. The simulation unit in Patent Document 1 differs from the simulation unit 110 described hereinafter in that the same includes: a machined-surface simulation display unit for displaying the result of a machined-surface simulation; and a display setting specification unit for making display settings for the machined-surface simulation display unit.

In order to implement functional blocks included in the NC device 100, the NC device 100 may be formed from a computer that includes: an arithmetic processing device such as a central processing unit (CPU); an auxiliary storage device such as a hard disk drive (HDD) storing various control programs such as application software or an operating system (OS); and a main storage device such as a random access memory (RAM) for storing data temporarily required when the arithmetic processing device runs a program. In the NC device 100, the arithmetic processing device reads the application software or the OS from the auxiliary storage device, and performs arithmetic processing based on the application software or the OS that has been read, while loading the application software or the OS into the main storage device, thereby implementing the functional blocks included in the NC device 100.

### <NC Device 100 and Servo Control Unit 200>

The storage unit 101 stores a machining program and tool information input thereto that include a command route (arrangement of command points) indicative of a machining route. On the basis of a machining execution instruction, the machining program and the tool information are read from the storage unit 101, and input to the smoothing control unit 102 and the simulation data output unit 105. The machining program includes a command route indicative of a machining route, the command route constituting machining position data.

The smoothing control unit 102 performs smoothing control for a movement route based on a movement command indicated by the machining program. Specifically, the smoothing control unit 102 compensates the movement command so as to achieve a smooth route, and then interpolates points on the movement route after compensation on an interpolation cycle (route compensation).

The acceleration/deceleration control unit 103 generates a movement speed pattern on the basis of the movement command interpolated by the smoothing control unit 102, an acceleration/deceleration based on an acceleration/deceleration time constant, and the maximum speed, generates a position command on the basis of the movement speed pattern, and outputs the position command to the machine coordinate transformation unit 104. The position command constitutes a control command for performing servo control for the servo motor 300, which drives the machine tool.

The machine coordinate transformation unit 104 transforms the position command output from the acceleration/deceleration control unit 103 from workpiece coordinates into machine coordinates, and outputs the position command transformed into machine coordinates to the servo control unit 200 and the simulation data output unit 105.

The simulation data output unit 105 outputs, to the coordinate conversion unit 106: machining position data from the machining program output from the storage unit 101; the position command (constituting machining position data) output from the machine coordinate transformation unit 104; machining position data that consists of motor feedback information (illustrated as MOTOR FB) constituting first feedback information output from the servo motor 300; and machining position data that consists of scale feedback information (illustrated as SCALE FB) constituting second feedback information output from the machine 400.

The coordinate conversion unit 106 converts the four pieces of machining position data output from the simulation data output unit 105 into machining position data for an identical coordinate system, and outputs the converted machining position data to the storage units 111-114.

The servo control unit 200 determines a position deviation constituting the difference between an input position command and a position detection value from at least either motor feedback information or scale feedback information, creates a speed command by using the position deviation, generates a torque command on the basis of the speed command, and outputs the torque command to the servo motor 300. The motor feedback information is a position detection value from a rotary encoder associated with the servo motor 300. The scale feedback information is a position detection value from a linear scale attached to the machine 400. The servo control unit 200 does not need to perform feedback control with two pieces of information, namely, the motor feedback information output from the servo motor 300 and the scale feedback information output from the machine 400. For example, the scale feedback information may be output only to the coordinate conversion unit 106 without being input to the servo control unit 200.

The rotation angle position of the servo motor 300 is detected by the rotary encoder associated with the servo motor 300, the rotary encoder constituting a position detection unit. The detected signal is integrated and then output to the servo control unit 200 and the simulation data output unit 105 as motor feedback information. Scale feedback information is a position detection value from the linear scale, which is attached to an end portion of a ball screw of the machine 400. The linear scale detects the movement distance of the ball screw, outputs a corresponding output to the servo control unit 200 as scale feedback information, and also inputs this output to the simulation data output unit 105 as position information pertaining to the ball screw, which constitutes a movable part of the machine 400.

The simulation unit 110 includes the storage unit 111, the storage unit 112, the storage unit 113, the storage unit 114, a simulation start command unit 115, a shape simulation unit 116, a shape simulation display unit 117, a check site specification unit 118, and a machined-surface simulation unit 119.

As indicated above, the storage units 111, 112, 113, and 114 store the machining position data from the machining program, the machining position data output from the machine coordinate transformation unit 104, the machining position data output from the servo motor 300, and the machining position data output from the machine 400. The pieces of machining position data stored by the storage units 111, 112, 113, and 114 are adapted to an identical coordinate system. N, which is the number of pieces of machining position data, is not limited to four, and may be two, three, or five or greater (N>2).

Upon a simulation start request being input to the NC device 100, the simulation start command unit 115 first reads, from the storage unit 111, the machining position data from the machining program, and sends a simulation start command and the machining position data from the machining program to the shape simulation unit 116. Note that: the initially read machining position data is not limited to the machining position data stored by the storage unit 111; and the machining position data stored by any of the storage units 111-114 may be initially read.

Upon receipt of the simulation start command, the shape simulation unit 116 performs a shape simulation with the machining position data from the machining program, and sends image information obtained from the shape simulation and indicating the shape of an object (hereinafter referred to as the workpiece) to the shape simulation display unit 117.

The shape simulation display unit 117 displays the shape of the workpiece on a screen on the basis of the image information indicating the shape of the workpiece. The shape simulation display unit 117 is, for example, a liquid-crystal display device with a touch panel. If the user finds an abnormality of the workpiece, which has actually been machined using the machine 400, through observation of the work, he/she uses the touch panel so as to specify a site on the workpiece that needs to be checked to detect the cause of occurrence of the abnormality.

The check site specification unit 118 sends, to the machined-surface simulation unit 119, coordinate information for specifying the site to be checked that has been specified using the touch panel. In this example, the entirety of the workpiece is specified as the site to be checked.

In cooperation with the simulation start command unit 115, the machined-surface simulation unit 119 performs a simulation (hereinafter referred to as the machined-surface simulation) of the machined surface in the manner described in the following.

The machined-surface simulation unit 119 identifies, on the basis of the coordinate information, machining position data pertaining to the site to be checked, and then initially performs a first machined-surface simulation.

The machined-surface simulation unit 119 reads the machining position data from the storage unit 111 or receives the same from the simulation start command unit 115, and uses the machining position data for the first machined-surface simulation. The first machined-surface simulation is performed, with a portion to be removed being calculated on the basis of position data and tool information.

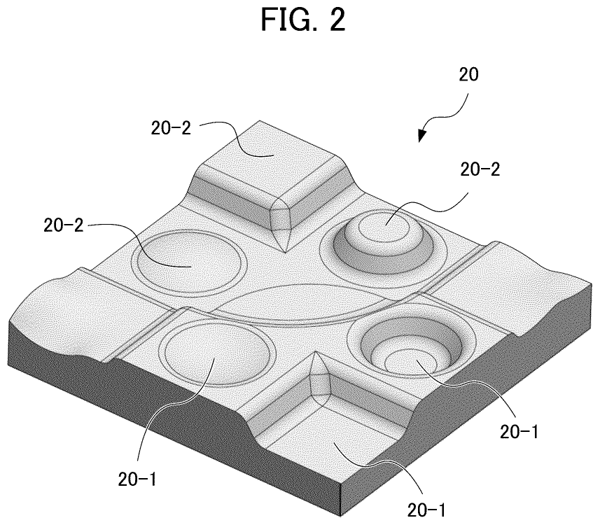

When the first machined-surface simulation with the machining position data from the machining program ends, the machined-surface simulation unit 119 sends an end report for the first machined-surface simulation to the simulation start command unit 115. The machined-surface simulation unit 119 stores coordinate information indicating the site to be checked. The machined-surface simulation unit 119 stores, in a machining-shape-model storage unit 501 described hereinafter, a first machining shape model obtained from the first machined-surface simulation. For example, the machining shape of the first machining shape model of the workpiece is the one depicted in the perspective view of FIG. 2. The shapes of three protruding/recessed portions 20-1 in FIG. 2 are opposite to the shapes of three protruding/recessed portions 20-2. The workpiece depicted in FIG. 2 is the workpiece for assessment described in Japanese Unexamined Patent Application, Publication No. 2019-040586.

Upon receipt of the end report for the first machined-surface simulation, the simulation start command unit 115 reads, from the storage unit 112, the machining position data output from the machine coordinate transformation unit 104, and sends, to the machined-surface simulation unit 119, the machining position data output from the machine coordinate transformation unit 104. In the meantime, since the coordinate information indicating the site to be checked has been stored by the machined-surface simulation unit 119, neither a shape simulation nor the specifying of the site to be checked needs to be performed, and the simulation start command unit 115 sends, directly to the machined-surface simulation unit 119, the machining position data output from the machine coordinate transformation unit 104.

The machined-surface simulation unit 119 performs the second machined-surface simulation with the machining position data output from the machine coordinate transformation unit 104 and, upon finishing the second machined-surface simulation, sends a second machined-surface simulation end report to the simulation start command unit 115. The machined-surface simulation unit 119 stores, in the machining-shape-model storage unit 501, a second machining shape model obtained from the second machined-surface simulation.

The above-described operations pertaining to the second machined-surface simulation are similarly performed for third and fourth machined-surface simulations. The machined-surface simulation unit 119 stores, in the machining-shape-model storage unit 501, third and fourth machining shape models obtained from the third and fourth machined-surface simulations.

### <Machining-Shape-Model Comparison Device 500>

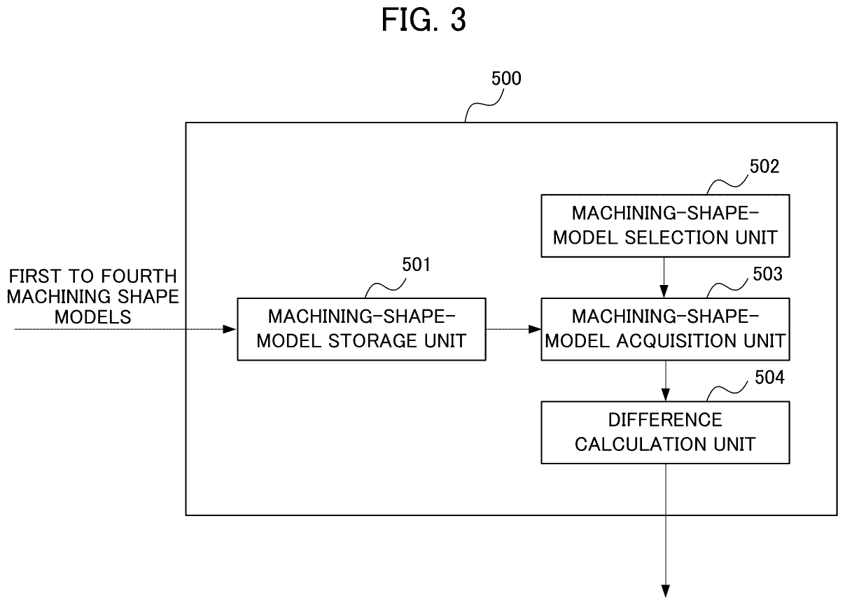

FIG. 3 is a block diagram illustrating one configuration example of the machining-shape-model comparison device according to the first embodiment of the present invention. As depicted in FIG. 3, the machining-shape-model comparison device 500 includes the machining-shape-model storage unit 501, a machining-shape-model selection unit 502, a machining-shape-model acquisition unit 503, and a difference calculation unit 504.

The machining-shape-model storage unit 501 stores: a first machining shape model obtained by performing a machined-surface simulation with the machining position data from the machining program; a second machining shape model obtained by performing a machined-surface simulation with the machining position data output from the machine coordinate transformation unit 104; a third machining shape model obtained by performing a machined-surface simulation with the machining position data output from the servo motor 300; and a fourth machining shape model obtained by performing a machined-surface simulation with the machining position data output from the machine 400. The number of stored machining shape models is not limited to four but is equal to N (N>2), which is the abovementioned number of pieces of machining position data.

The machining-shape-model selection unit 502 selects, from the first to fourth machining shape models stored by the machining-shape-model storage unit 501, at least two pairs of machining shape models in two adjacent processes. Two pairs are selected such that the two pairs include an identical machining shape model. The purpose of this is to grasp which process from among the plurality of time series processes for the workpiece has caused an abnormality of the machined surface of the workpiece.

The NC machine system 10, excluding the machining-shape-model comparison device 500, generates the first to fourth machining shape models by being operated in a plurality of processes including four serial processes of: reading the machining program; generating a position command; outputting motor feedback information from the servo motor 300; and outputting scale feedback information from the machine 400 driven by the servo motor 300.

Accordingly, pairs of machining shape models in two adjacent processes correspond to: the pair of the first machining shape model and the second machined surface shape model; and the pair of the second machining shape model and the third machined surface shape model or the pair of the third machining shape model and the second machined surface shape model. The method for selecting at least two pairs of machining shape models may be determined in advance or may be specified by the user.

The following description is based on the assumption that the machining-shape-model selection unit 502 selects: the pair of the first machining shape model and the second machined surface shape model; the pair of the second machining shape model and the third machined surface shape model; and the pair of the second machining shape model and the third machined surface shape model.

The machining-shape-model acquisition unit 503 acquires, from the machining-shape-model storage unit 501, the first and second machining shape models selected by the machining-shape-model selection unit 502.

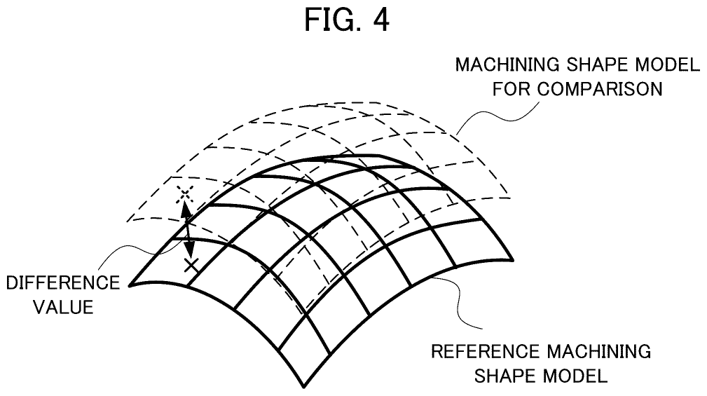

The difference calculation unit 504 determines, as a difference value, the distance between the machined surfaces of the first and second machining shape models output from the machining-shape-model acquisition unit 503. FIG. 4 is a schematic explanatory view illustrating a method for determining the distance between machined surfaces of two machining shape models as a difference value. FIG. 4 depicts the two machining shape models with curved surfaces for simplification, one of the two machining shape models being the reference, the other being an object for comparison. For example, the first machined surface shape model is the reference, and the first machined surface shape model is the object for comparison. In FIG. 4, the reference machining shape model is indicated by solid lines, and the machining shape model for comparison is indicated by broken lines.

As depicted in FIG. 4, the machined surface of the reference machining shape model is segmented into meshes. The reference machining shape model is compared with the machining shape model for comparison, and a distance that is equal to the length of a line nominal to each mesh on the machined surface of the reference machining shape model and intersecting the machined surface of the machining shape model for comparison is defined as the difference value of the mesh. The difference calculation unit 504 determines a difference value for each of the meshes and outputs a set of the difference values of the meshes (hereinafter referred to as the first set of difference values).

The machining-shape-model acquisition unit 503 acquires, from the machining-shape-model storage unit 501, the second and third machining shape models selected by the machining-shape-model selection unit 502. Note that, since the machining-shape-model acquisition unit 503 has already read the second machining shape model in order to determine the first set of difference values, the already read second machining shape model does not need to be read again as long as the second machining shape model is stored in a storage unit. As in the method for determining the first set of difference values, the difference calculation unit 504 determines the distance between the machined surface of the second machining shape model and the machined surface of the third machining shape model as a difference value for each of the meshes, and outputs a set of the difference values of the meshes (hereinafter referred to as the second set of difference values).

Similarly, the machining-shape-model acquisition unit 503 acquires, from the machining-shape-model storage unit 501, the third and fourth machining shape models selected by the machining-shape-model selection unit 502. As in the method for determining the first set of difference values, the difference calculation unit 504 determines the distance between the machined surface of the third machining shape model and the machined surface of the fourth machining shape model as a difference value for each of the meshes, and outputs a set of the difference values of the meshes (hereinafter referred to as the third set of difference values).

The user can determine which process has a high likelihood of having caused an abnormality according to the first set of difference values, the second set of difference values, and the third set of difference values, which have been output from the difference calculation unit 504. For example, if the distribution of the first set of difference values lies within a normal range and the distribution of the second set of difference values does not lie within the normal range, the user finds out that the abnormality of the machined surface of the workpiece is based on the servo control by the servo control unit 200.

For example, if the distributions of the first and second sets of difference values lie within the normal range and the distribution of the third set of difference values does not lie within the normal range, the user finds out that the abnormality of the machined surface of the workpiece is based on a machine operation.

In the present embodiment, at least two pairs of machining shape models may be selected from the first to fourth machining shape models so as to determine two sets of difference values. For example, only the first and second sets of difference values may be determined when it has been found that the abnormality of the machined surface of a workpiece is not based on a machine operation.

In order to implement the functional blocks included in the machining-shape-model comparison device 500 depicted in FIG. 3, the machining-shape-model comparison device 500 may be formed from a computer including an arithmetic processing device such as a central processing unit (CPU). The machining-shape-model comparison device 500 also includes: an auxiliary storage device such as a hard disk drive (HDD) storing various control programs such as application software or an operating system (OS); and a main storage device such as a random access memory (RAM) for storing data temporarily required when the arithmetic processing device runs the program.

In the machining-shape-model comparison device 500, the arithmetic processing device reads the application software or the OS from the auxiliary storage device, and performs arithmetic processing based on the application software or the OS that has been read, while loading the application software or the OS into the main storage device. Various types of hardware of the machining-shape-model comparison device 500 are controlled on the basis of the result of arithmetic processing. In this way, the functional blocks in the present embodiment are implemented. Accordingly, the present embodiment can be implemented through the cooperation between hardware and software.

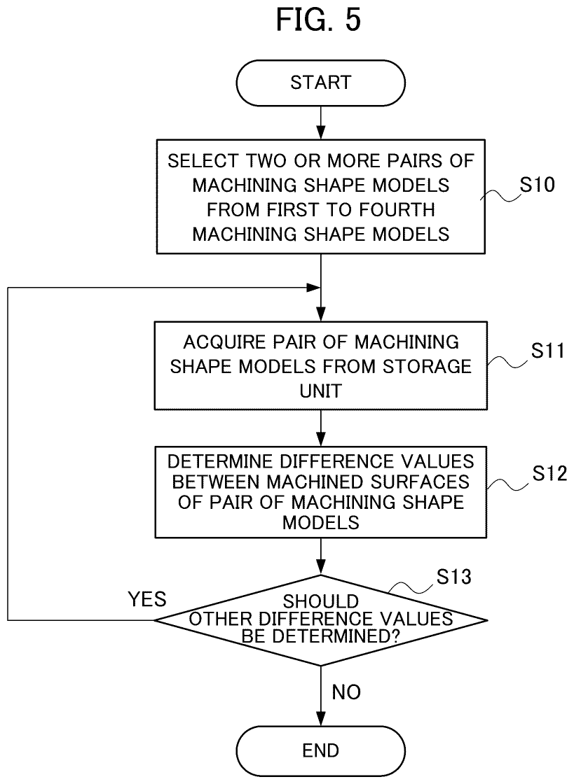

The following describes operations of the machining-shape-model comparison device 500 with the flowchart of FIG. 5. In Step S10, the machining-shape-model selection unit 502 selects, from first to fourth machining shape models stored by the machining-shape-model storage unit 501, at least two pairs of machining shape models in two adjacent processes. Two pairs are selected such that the two pairs include an identical machining shape model.

In Step S11, the machining-shape-model acquisition unit 503 acquires, from the machining-shape-model storage unit 501, two machining shape models included in one pair of machining shape models selected by the machining-shape-model selection unit 502.

In Step S12, the difference calculation unit 504 determines a difference value for each mesh of the two machining shape models acquired from the machining-shape-model acquisition unit 503, and outputs a set of difference values. Each difference value is a distance that is equal to the length of a line nominal to a mesh of one of the machining shape models and intersecting the machined surface of the other machining shape model.

In Step S13, it is determined whether to determine difference values for the other pair of machining shape models. In the case of determining difference values for the other pair of machining shape models, i.e., the other two machining shape models (“YES” in Step S14), the process returns to Step S11. In the case of not determining difference values for the other pair of machining shape models (“NO” in Step S14), the process ends. In the meantime, since at least two pairs of machining shape models are selected, Steps S11-S13 are repeated at least twice.

### Second Embodiment

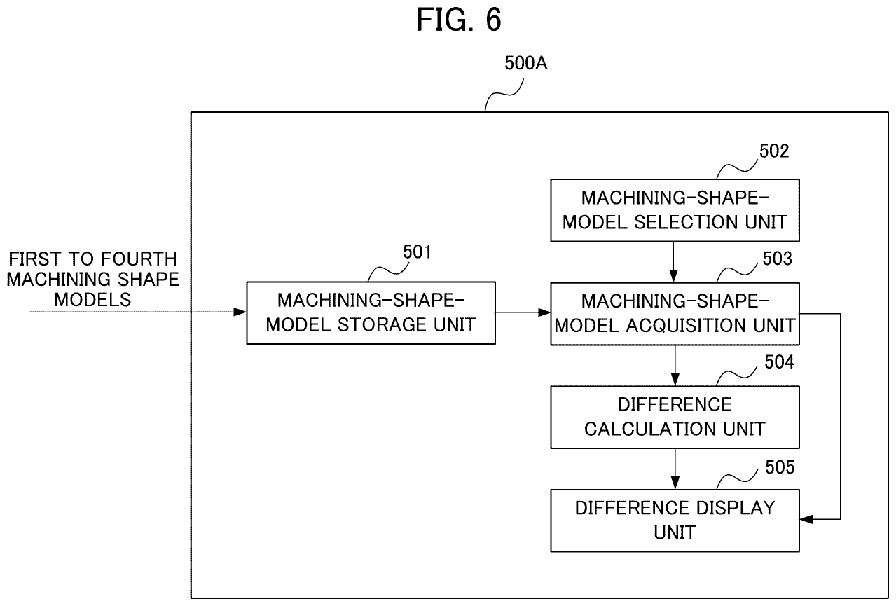

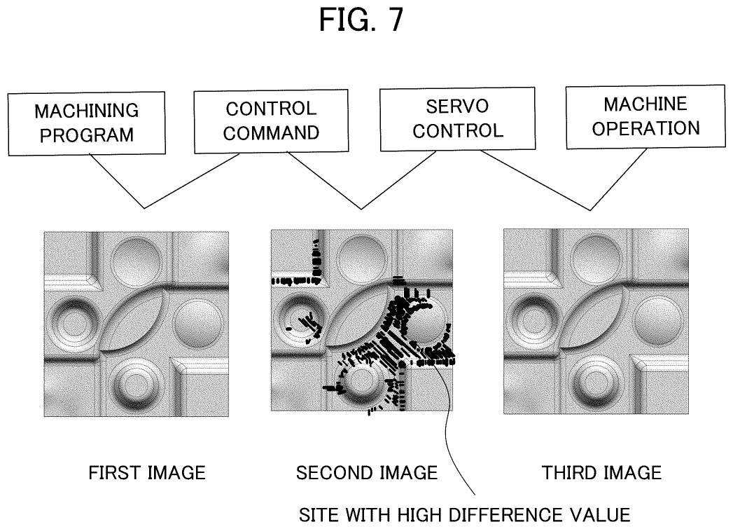

In the present embodiment, a set of difference values output from the difference calculation unit 504 is displayed on a machining shape model with colors. FIG. 6 is a block diagram illustrating one configuration example of the machining-shape-model comparison device according to the second embodiment of the present invention. The NC machine system configuration excluding the machining-shape-model comparison device is the same as that of the NC machine system 10 depicted in FIG. 1. The machining-shape-model comparison device 500A according to the present embodiment is the machining-shape-model comparison device 500 depicted in FIG. 3 with a difference display unit 505 added thereto. FIG. 7 illustrates a display screen of the difference display unit.

The difference display unit 505 displays a first image on the display screen of a display device such as a liquid-crystal display device. The first image is an image of the machined surface of the first machining shape model output from the machining-shape-model acquisition unit 503, with the difference value of each mesh of the first and second machining shape models being rendered with a color corresponding to the difference value.

The difference display unit 505 also displays a second image on the display screen of the display device such as a liquid-crystal display device. The second image is an image of the surface of the second machining shape model output from the machining-shape-model acquisition unit 503, with the difference value of each mesh of the second and third machining shape models being rendered with a color corresponding to the difference value.

The difference display unit 505 displays a third image on the display screen of the display device such as a liquid-crystal display device. The third image is an image of the surface of the third machining shape model output from the machining-shape-model acquisition unit 503, with the difference value of each mesh of the third and fourth machining shape models being rendered with a color corresponding to the difference value. The first, second, and third images are arranged in the lateral direction on the display screen. The direction in which the first to third images are arranged is not particularly limited to the lateral direction and may be, for example, the longitudinal direction.

In FIG. 7, the difference display unit 505 displays the second image such that sites corresponding to individual meshes with a difference value exceeding a prescribed threshold are black-colored, and displays the first and third images such that sites corresponding to individual meshes with a difference value equal to or less than the prescribed threshold are not colored (not black-colored). The wording “display according to a difference value” refers to situations including one in which a color is not used when the difference value is equal to or less than a prescribed threshold. By viewing the display screen in FIG. 7, the user finds that the abnormality of the machined surface of the workpiece is based on servo control by the servo control unit 200 because the second image includes a multitude of sites corresponding to individual meshes with a difference value exceeding the prescribed threshold.

Two thresholds for assessing a difference value may be provided such that: blue is selected when the difference value of an individual mesh is equal to or less than a first threshold d1; green is selected when the difference value is greater than the first threshold d1 and equal to or less than a second threshold d2 (d2>d1); and red is selected when the difference value is greater than the second threshold d2. In this case, variations in difference value can be determined by checking sites rendered with blue, green, or red in one image. Meanwhile, three or more thresholds may be provided. In the above description, the image is displayed with colors according to the range of the difference values of individual meshes. However, the image may be displayed with, for example, light and shade or fill patterns. Furthermore, a pin may be provided at a site with a difference value exceeding the prescribed threshold.

### Third Embodiment

The first and second embodiments have been described by referring to the example in which: at least two pairs of machining shape models are selected from the first to fourth machining shape models stored by the machining-shape-model storage unit 501; and the distance between the machined surfaces of the machining shape models is determined for each mesh as a difference value. In the first and second embodiments, an assessment can be made as to which process has caused an abnormality of the machined surface of a workpiece.

In the present embodiment, at least one pair of machining shape models is selected from among first to fourth machining shape models, the distance between the machined surfaces of the machining shape models is determined for each mesh as a difference value, and a statistic pertaining to a set of difference values is determined as an evaluation value. The statistic is a value indicative of a characteristic of a set of data and is, for example, an average, a variance, or a standard deviation.

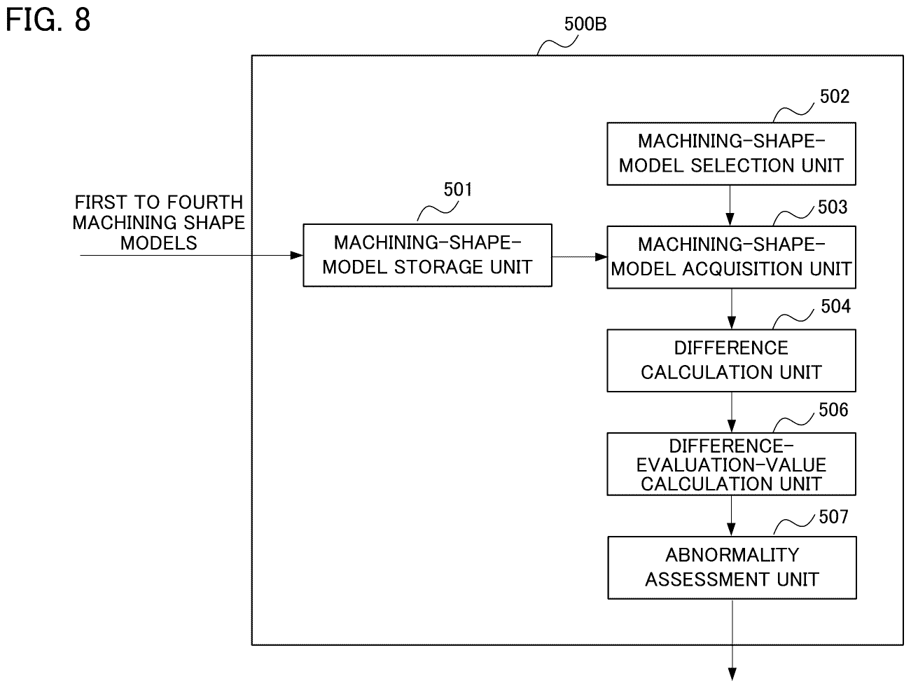

FIG. 8 is a block diagram illustrating one configuration example of the machining-shape-model comparison device according to the third embodiment of the present invention. The NC machine system configuration excluding the machining-shape-model comparison device is the same as that of the NC machine system 10 depicted in FIG. 1. The machining-shape-model comparison device 500B according to the present embodiment is the machining-shape-model comparison device 500 depicted in FIG. 3 with a difference-evaluation-value calculation unit 506 and an abnormality assessment unit 507 added thereto. If no abnormality assessments are made, the abnormality assessment unit 507 does not need to be provided.

The machining-shape-model selection unit 502 selects, from the first to fourth machining shape models stored by the machining-shape-model storage unit 501, at least one pair of machining shape models in two adjacent processes. The method for selecting a pair of machining shape models may be determined in advance or may be specified by the user. The following description is based on the assumption that the machining-shape-model selection unit 502 selects the pair of first machining shape model and the second machined surface shape models.

The machining-shape-model acquisition unit 503 acquires, from the machining-shape-model storage unit 501, the first and second machining shape models selected by the machining-shape-model selection unit 502.

As in the first embodiment, the difference calculation unit 504 determines, as a difference value, the distance between the machined surfaces of the first and second machining shape models output from the machining-shape-model acquisition unit 503. The difference calculation unit 504 determines a difference value for each of the meshes and outputs a set of the difference values of the meshes (first set of difference values).

The difference-evaluation-value calculation unit 506 determines the average of the first set of difference values by totalizing the absolute values of the difference values of the individual meshes and dividing the total by the number of meshes, and outputs the average as a first evaluation value. If the average of the first set of difference values is greater than a prescribed threshold, the abnormality assessment unit 507 may assess that a control command based on the machining program has caused the abnormality of the machined surface of the workpiece.

In the present embodiment, the difference calculation unit 504 may calculate, as in the first embodiment, the second and third sets of difference values in addition to the first set of difference values. In this case, as described above, the difference-evaluation-value calculation unit 506 determines and outputs the average of the first set of difference values, outputs the average of the second set of difference values after determining the same by totalizing the absolute values of the difference values of the individual meshes and dividing the total by the number of meshes, and outputs the average of the third set of difference values after determining the same by totalizing the absolute values of the difference values of the individual meshes and dividing the total by the number of meshes.

The abnormality assessment unit 507 can assess which process has a high likelihood of having caused the abnormality according to the average of the first set of difference values, the average of the second set of difference values, and the average of the third set of difference values. Assume, for example, that the average of the first set of difference values is 1.01, the average of the second set of difference values is 3.85, and the average of the third set of difference values is 0.98, where the average of a set of typical difference values is 1. In this case, the abnormality assessment unit 507 can assess that the abnormality of the machined surface of the workpiece is based on the servo control by the servo control unit 200.

While embodiments of the present invention have been described so far, each component of the abovementioned machining-shape-model comparison devices may be implemented by hardware, software, or a combination thereof. In this regard, the wording “implemented by software” means being implemented by a computer reading a program.

The program may be stored using various types of non-transitory computer readable media and supplied to the computer. The non-transitory computer readable media include various types of tangible storage media. The non-transitory computer readable media include, for example, magnetic recording media (e.g., hard disk drive), magneto-optical recording media (e.g., magneto-optical disk), read only memories (CD-ROMs), CD-Rs, CD-R/Ws, and semiconductor memories (e.g., Mask ROM, programmable ROM (PROM), erasable PROM (EPROM), flash ROM, random access memory (RAM)).

The embodiments described above are preferred ones of the present invention. However, the present invention is not limited only to the described embodiments, and various changes can be made without departing from the gist of the present invention.

The machining-shape-model comparison device and the numerical control machine system of the present disclosure can implement various types and forms of embodiments provided with the following configurations, including the embodiments described above.

(1) A machining-shape-model comparison device (machining-shape-model comparison device 500, 500A, 500B) including: a machining-shape-model storage unit (e.g., machining-shape-model storage unit 501) that stores at least a first machining shape model, a second machining shape model, and a third machining shape model that are generated on the basis of three pieces of machining position data pertaining to at least three serial processes when an object is machined with a machine tool; a machining-shape-model selection unit (e.g., machining-shape-model selection unit 502) that selects the first and second machining shape models and the second and third machining shape models that are stored by the machining-shape-model storage unit; a machining-shape-model acquisition unit (e.g., machining-shape-model acquisition unit 503) that acquires the first and second machining shape models and the second and third machining shape models that have been selected by the machining-shape-model selection unit; and a difference calculation unit (e.g., difference calculation unit 504) that determines, as a first set of difference values, a set of distances between machined surfaces of the first machining shape model and the second machining shape model acquired by the machining-shape-model acquisition unit, and determines, as a second set of difference values, a set of distances between machined surfaces of the second machining shape model and the third machining shape model acquired by the machining-shape-model acquisition unit. When there are at least three serial processes in machining an object with a machine tool, this machining-shape-model comparison device allows the user to easily identify which process has caused an abnormality of the machined surface of the object that has been machined.

(2) The machining-shape-model comparison device described above in (1), including a difference display unit (e.g., difference display unit 505) that displays at least a portion of the first set of difference values on the first machining shape model or the second machining shape model according to the first difference values, and displays at least a portion of the second set of difference values on the second machining shape model or the third machining shape model according to the second difference values. This machining-shape-model comparison device allows a site exhibiting a difference to be visually identified.

(3) The machining-shape-model comparison device described in (1) or (2) above, including a difference-evaluation-value calculation unit (e.g., difference-evaluation-value calculation unit 506) that determines a statistic pertaining to the first set of difference values as a first evaluation value, and determines a statistic pertaining to the second set of difference values as a second evaluation value. This machining-shape-model comparison device allows the set of first difference values to be quantitatively compared with the set of second difference values.

(4) The machining-shape-model comparison device described in (3) above, wherein the first evaluation value is the average, variance, or standard deviation of the set of first difference values, and the second evaluation value is the average, variance, or standard deviation of the set of second difference values.

(5) The machining-shape-model comparison device described in (3) or (4) above, including an abnormality assessment unit (e.g., abnormality assessment unit 507) that assesses, on the basis of the first evaluation value and the second evaluation value, which process from among the at least three serial processes has caused an abnormality. This machining-shape-model comparison device allows an assessment to be automatically made as to which process from among at least three serial processes has caused an abnormality of an object.

(6) A machining-shape-model comparison device including:
a machining-shape-model storage unit that stores at least a first machining shape model and a second machining shape model that are generated on the basis of two pieces of machining position data pertaining to at least two serial processes when an object is machined with a machine tool; a machining-shape-model selection unit that selects the first and second machining shape models stored by the machining-shape-model storage unit; a machining-shape-model acquisition unit that acquires the first and second machining shape models selected by the machining-shape-model selection unit; and a difference calculation unit that determines, as a set of difference values, a set of distances between machined surfaces of the first machining shape model and the second machining shape model acquired by the machining-shape-model acquisition unit; and a difference-evaluation-value calculation unit that determines a statistic pertaining to the set of difference values as an evaluation value. This machining-shape-model comparison device allows a quantitative assessment to be made as to which process has caused an abnormality of the machined surface of an object that has been machined.

(7) A numerical control machine system including: the machining-shape-model comparison device described in any one of (1) to (5) above; and a numerical control device that includes a simulation unit for generating at least first, second, and third machining shape models on the basis of three pieces of machining position data pertaining to at least three serial processes when an object is machined with a machine tool.

(8) A computer-readable information storage medium having stored therein a program for causing a computer to store at least a first machining shape model, a second machining shape model, and a third machining shape model that are generated on the basis of three pieces of machining position data pertaining to at least three serial processes when an object is machined with a machine tool, select the first and second machining shape models and the second and third machining shape models that have been stored, acquire the first and second machining shape models and the second and third machining shape models that have been selected, and determine, as a first set of difference values, a set of distances between machined surfaces of the first machining shape model and the second machining shape model that have been acquired, and determine, as a second set of difference values, a set of distances between machined surfaces of the second machining shape model and the third machining shape model that have been acquired. When there are at least three serial processes in machining an object with a machine tool, this computer-readable information storage medium allows, by using the stored program, the user to easily identify which process has caused an abnormality of the machined surface of the object that has been machined.

### EXPLANATION OF REFERENCE NUMERALS

10: NC machine system
100: NC device
110: Simulation unit
200: Servo control unit
300: Servo motor
400: Machine
500, 500A, 500B: Machining-shape-model comparison device
501: Machining-shape-model storage unit
502: Machining-shape-model selection unit
503: Machining-shape-model acquisition unit
504: Difference calculation unit
505: Difference display unit
506: Difference-evaluation-value calculation unit
507: Abnormality assessment unit

1. A machining-shape-model comparison device comprising:
a machining-shape-model storage unit that stores at least a first machining shape model, a second machining shape model, and a third machining shape model that are generated on a basis of three pieces of machining position data pertaining to at least three serial processes when an object is machined with a machine tool;
a machining-shape-model selection unit that selects the first and second machining shape models and the second and third machining shape models that are stored by the machining-shape-model storage unit;
a machining-shape-model acquisition unit that acquires the first and second machining shape models and the second and third machining shape models that have been selected by the machining-shape-model selection unit; and
a difference calculation unit that determines, as a first set of difference values, a set of distances between machined surfaces of the first machining shape model and the second machining shape model acquired by the machining-shape-model acquisition unit, and determines, as a second set of difference values, a set of distances between machined surfaces of the second machining shape model and the third machining shape model acquired by the machining-shape-model acquisition unit.

2. The machining-shape-model comparison device according to claim 1, comprising a difference display unit that displays at least a portion of the first set of difference values on the first machining shape model or the second machining shape model according to the first difference values, and displays at least a portion of the second set of difference values on the second machining shape model or the third machining shape model according to the second difference values.

3. The machining-shape-model comparison device according to claim 1, comprising a difference-evaluation-value calculation unit that determines a statistic pertaining to the first set of difference values as a first evaluation value, and determines a statistic pertaining to the second set of difference values as a second evaluation value.

4. The machining-shape-model comparison device according to claim 3, wherein the first evaluation value is an average, variance, or standard deviation of the set of first difference values, and the second evaluation value is an average, variance, or standard deviation of the set of second difference values.

5. The machining-shape-model comparison device according to claim 3, comprising an abnormality assessment unit that assesses, on a basis of the first evaluation value and the second evaluation value, which process from among the at least three serial processes has caused an abnormality.

6. A machining-shape-model comparison device comprising:
a machining-shape-model storage unit that stores at least a first machining shape model and a second machining shape model that are generated on a basis of two pieces of machining position data pertaining to at least two serial processes when an object is machined with a machine tool;
a machining-shape-model selection unit that selects the first and second machining shape models stored by the machining-shape-model storage unit;
a machining-shape-model acquisition unit that acquires the first and second machining shape models selected by the machining-shape-model selection unit; and
a difference calculation unit that determines, as a set of difference values, a set of distances between machined surfaces of the first machining shape model and the second machining shape model acquired by the machining-shape-model acquisition unit; and
a difference-evaluation-value calculation unit that determines a statistic pertaining to the set of difference values as an evaluation value.

7. A numerical control machine system comprising:
the machining-shape-model comparison device according to claim 1; and
a numerical control device including a simulation unit that generates at least first, second, and third machining shape models on a basis of three pieces of machining position data pertaining to at least three serial processes when an object is machined with a machine tool.

8. A computer-readable information storage medium having stored therein a program for causing a computer to
store at least a first machining shape model, a second machining shape model, and a third machining shape model that are generated on a basis of three pieces of machining position data pertaining to at least three serial processes when an object is machined with a machine tool,
select the first and second machining shape models and the second and third machining shape models that have been stored,
acquire the first and second machining shape models and the second and third machining shape models that have been selected, and
determine, as a first set of difference values, a set of distances between machined surfaces of the first machining shape model and the second machining shape model that have been acquired, and determine, as a second set of difference values, a set of distances between machined surfaces of the second machining shape model and the third machining shape model that have been acquired.
